(19) United States
(12) Patent Application Publication
(10) Pub. No.: US 2007/0127750 A1
(43) Pub. Date: Jun. 7, 2007

(54) Hearing device with virtual sound source

(75) Inventors: Raoul Glatt, Zurich (CH); Bernd Waldmann, Maur (CH)

Correspondence Address: PEARNE & GORDON LLP, 1801 EAST 9TH STREET, SUITE 1200, CLEVELAND, OH, 44114-3108, US

(73) Assignee: Phonak AG, Stafa (CH)

(21) Appl. No.: 11/299,074

(22) Filed: Dec. 7, 2005

(51) Int. Cl. H04R 25/00

(52) U.S. Cl. 381/312

(57) ABSTRACT

The hearing system comprises at least one hearing device; at least one input unit adapted to receiving incoming signals and obtaining input audio signals from said incoming signals; at least one output transducer adapted to converting audio signals into output signals to be perceived by a user of the hearing system; at least one sound generator adapted to generating system-generated audio signals; an audio analysis unit adapted to obtaining localization information from said input audio signals; and a virtual localization processor adapted to providing said system-generated audio signals with spatial information, thus creating spatialized system-generated audio signals, wherein said spatial information is chosen in dependence of said localization information. Said virtual location may be varied while said spatialized system-generated audio signals are perceived by the user as output signals, and this variation of said virtual location may be indicative of an operational condition of the hearing system. The hearing system may comprise exactly one hearing device or a number of hearing devices, which are not linked amongst each other.

### TECHNICAL FIELD

The invention relates to a hearing system, which comprises at least one hearing device, and which is capable of generating sounds or signals to be perceived by a user of the hearing system. The hearing device can be a hearing aid, worn in or near the ear or implanted, a headphone, an earphone, a hearing protection device, a communication device or the like.

### State of the Art

From DE 10 2004 035 046 A1, binaural hearing systems are known, which provide for “virtual sound sources” in the sense that system-generated sounds can be perceived by a user of the system as if they were generated in certain locations near the user. The system-generated sounds are processed with HRTF (head-related transfer functions) for each ear, so that the user's left and right ears will typically perceive, at slightly different times, slightly different signals, such that the origin of the system-generated sound appears to be in a specific fixed location near the user. The two hearing devices are linked with each other in order to be able to provide a synchronization of the hearing device necessary to achieve a required timing precision for signals played to the user's left and right ears.

From US 2005/0152567 A1, a hearing aid is known, which is capable of generating sounds (device signals) as a function of a hearing aid value, e.g., a battery status. Said device signals can be adjusted in level or type, based on a level of an input signal and a signal shape of the input signal or on a classification of the input signal. In addition, said input signal may be adjusted with respect to the device signal. For example, the level of the device signal is increased when the user is in a loud environment (high input signal) and/or the gain for the input signal is decreased (up to muting) when a device signal is to be output.

### SUMMARY OF THE INVENTION

A goal of the invention is to create a hearing system and a method of operating a hearing system, that allow for a clear perception of system-generated signals by a user of the system.

One object of the invention is to provide for a hearing system and a method,of operating a hearing system, which provide for a good distinguishability between different system-generated signals.

Another object of the invention is to provide for a hearing system and a method of operating a hearing system, which allow for a clear perception of system-generated signals without a linked pair of hearing devices.

Another object of the invention is to provide for a hearing system without a linked pair of hearing devices and a method of operating such a hearing system, which provide for a good distinguishability between different system-generated signals.

These objects are achieved by hearing systems and by methods according to the patent claims.

In a first aspect of the invention, the hearing system comprises
at least one hearing device;
at least one input unit adapted to receiving incoming signals and obtaining input audio signals from said incoming signals;
at least one output transducer adapted to converting audio signals into output signals to be perceived by a user of the hearing system;
at least one sound generator adapted to generating system-generated audio signals;
an audio analysis unit adapted to obtaining localization information from said input audio signals; and
a virtual localization processor adapted to providing said system-generated audio signals with spatial information, thus creating spatialized system-generated audio signals, wherein said spatial information is chosen in dependence of said localization information.

The corresponding method for operating a hearing system comprising at least one hearing device comprises the steps of
receiving incoming signals;
obtaining input audio signals from said incoming signals;
obtaining localization information from said input audio signals;
generating system-generated audio signals;
choosing, in dependence of said localization information, spatial information to provide said system-generated audio signals with;
providing said system-generated audio signals with said spatial information, thus creating spatialized system-generated audio signals;
converting said spatialized system-generated audio signals into output signals to be perceived by a user of the hearing system.

Through this, an improved perception of system-generated signals by a user of the hearing system can be achieved. Said providing of said system-generated audio signals with said spatial information can also be called or considered a providing of said system-generated audio signals with spaciousness

Said system-generated audio signals can be provided with said spatial information in order to achieve the effect, that said spatialized system-generated audio signals, when perceived by the user as output signals, are perceived by the user as signals originating from a virtual location, wherein said virtual location is chosen in dependence of said localization information.

The spatialization of the system-generated signals gives the user the impression that the signals perceived by him, when said spatialized system-generated audio signals are converted in said output converter into output signals, originate from a virtual location. And that virtual location is chosen in dependence of said localization information.

A virtual location is defined by an apparent distance from the user and/or an apparent azimuthal angle and/or an apparent polar angle, where the signals are apparently coming from. It may comprise apparent room information (information of size and/or shape and/or surfaces and the like of a room inside of which the system-generated sounds are apparently originating in). An apparent distance may result from various effects, among which are damping (reduction of high-frequency components) and reflections.

Said hearing system may comprise one hearing device or two hearing devices, which may be linked (wirelessly or wire-bound) or not-linked. Hearing devices are usually worn in or near a user's ear, or may be implanted. Hearing systems may furthermore comprise remote controls and other accessories.

Typically, said incoming signals are incoming sound (acoustical sound). They may also be of other nature, e.g., electromagnetic waves, e.g., when the hearing system receives frequency modulated radio waves from a speech inside a filled auditorium with the user being inside or outside the auditorium with his hearing system.

Said input unit may comprise one or more input converters, which are typically mechanical-to-electrical converters (e.g., microphones), but converters receiving electromagnetic waves and converting these into audio signals are also possible (e.g., in case of a telephone coil or of a remote frequency modulation receiver or infrared receiver).

Audio signals are usually electrical signals, analogue and/or digital, which describe or represent sound (natural sound or artificially generated sound).

Said output signals are often acoustic signals (sound, sound waves), but may be other signals as well, e.g., in the case of implanted hearing devices. Said output transducers can therefore be electro-to-mechanical converters (loudspeakers) or others, e.g., electrical-to-electrical converters.

Typically, each hearing device comprises one output transducer.

Typically, each hearing device comprises one, possibly two or even more, input transducers.

Typically, at least one or each hearing device comprises a sound generator, which may be realized in form of software.

Said audio analysis unit is typically a software-implemented signal processing algorithm. From the received input signals, information on where in space the input audio signals or a part or different parts of the input signals come from (localization information) is extracted. In case that only one stream of input audio signals is received, e.g., when only one hearing device with only one microphone is comprised in the hearing system, localization information in terms of information on a room (size, shape, surfaces) in which acoustic waves travelled from which the input audio signals are obtained, can be obtained. Mainly, reverberation and echo portions (signals, components) in the input audio signals provide for the necessary information. Furthermore, localization information in terms of distance information is obtainable, at least a maximum distance as obtained from said room information.

If, e.g., two streams of incoming signals are received by the input unit, which, e.g., is the case when the input unit comprises two microphones or when an electrical-electrical converter (of the input unit) receives a stereo signal, localization information may be obtained from a time delay (time-of-reception difference) and/or the loudness difference (level difference) between the two audio streams. In the art, such audio analysis units are also known as localizers and used in conjunction with beam formers. Classifiers, which are also known in the art, may also be used, since they may allow to distinguish between different sound sources if more than one principal sound sources exist.

By analyzing spectral differences (differences in spectral coloration) of the two streams of incoming signals, it is possible to derive directional information. This can be achieved by comparing said spectral coloration with HRTF (head-related transfer functions), which describe such frequency-dependent sound modifications.

From the sketched analyses of the two streams of input audio signals, a rather precise determination of the direction, in which a sound source is located relative to the microphones, is thus enabled, e.g., in terms of an azimuthal and a polar angle with respect to the user's head. In addition, also distance information may be extracted, e.g., as sketched above in conjunction with the analysis of one single stream of input audio signals.

Once said localization information is obtained, it can be decided, where to arrange said virtual location. If, e.g., only one principal sound source is detected, which comprises a lot of reverberation or is located far away, the virtual location could be arranged close to the user.

If the one principal sound source is located to the very right of the user, the virtual location could be arranged to the very left of the user. If, on the other hand, e.g., a principal sound source is located in front of the user, and a major noise source is located far away on the right behind the user, the virtual sound source could be arranged on the left behind and close to the user. In a generally loud environment, the virtual location could be arranged within the user's head.

Said virtual localization processor may be implemented in form of software and generates the reverberation and/or echo signals, and the interaural time differences, the interaural level differences and the different spectral coloration of output signals to be perceived by each of the user's two ears, which are required (and possible) to let the virtual sound source appear in the desired location (with the desired spaciousness). Individually measured and/or averaged or estimated HRTF may be used.

Said system-generated audio signals may be provided with at least one of interaural time differences, interaural level differences, and different spectral coloration of output signals to be perceived by each of the user's two ears as spatial information.

In one embodiment, the kind and/or the amount of said spatial information is chosen in dependence of at least one of a gain model describing hearing preferences of said user and an analysis of said input audio signals. Said analysis of said input audio signals can comprise classifications as they are known in the art. Said gain model takes the user's individual preferences (in case of hearing aids: mostly individual hearing deficiencies) into account.

Typically, the invention can be used in conjunction with acknowledge signals (or other sound messages) as the system-generated audio signals to be perceived by the hearing system user. In particular, said system-generated audio signals may be speech signals.

Acknowledge sounds, also called feedback sounds, are played to the user upon a change in the hearing device's function, e.g., when the user changes the loudness (volume) or another setting or program of one or both hearing devices, or when some other user's manipulation shall be acknowledged, or when the hearing device by itself takes an action, e.g., by making a change, e.g., if, in the case of a hearing aid, the hearing aid chooses, in dependence of the acoustical environment, a different hearing program (frequency-volume settings and the like), or when the hearing device user shall be informed that a hearing device's energy source (battery) is low. Acknowledge sounds can be considered signals that indicate a change in an operational condition of the hearing system.

In a second aspect of the invention, the hearing system comprises
at least one hearing device;
at least one output transducer adapted to converting audio signals into output signals to be perceived by a user of the hearing system;
at least one sound generator adapted to generating system-generated audio signals; and
a virtual localization processor adapted to providing said system-generated audio signals with spatial information, thus creating spatialized system-generated audio signals, in order to achieve the effect that said spatialized system-generated audio signals, when perceived by the user as output signals, are perceived by the user as signals originating from a virtual location;
   wherein said virtual location is varied while said spatialized system-generated audio signals are perceived by the user as output signals, and wherein this variation of said virtual location is indicative of an operational condition of the hearing system.

It has been found that it is not always easy for a human being to locate a sound source, in particular, an unmoved sound source. To tell a location difference between two unmoved (fixed) sound sources can be rather difficult. It has been found that it is far easier to clearly identify a movement of a sound source and to distinguish different movements of sound sources. This applies also (and in particular—due to the usually imperfect simulation) to virtual sound sources. Accordingly, as described in said second aspect of the invention, it can be advantageous to associate the (virtual) movement of a spatialized system-generated audio signal with a meaning. E.g., in order to acknowledge that the user has increased the volume of his hearing device, a system-generated sound could virtually rise from about eye-level to well above the user's head. Or, e.g., a change from a hearing program (e.g., number 3) to a hearing program with the next higher number (number 4) could be indicated by a virtual move of the appropriate acknowledge signal (e.g., a speech signal saying “program four”) from left to right. In the case that HRTF (head-related transfer functions) are used as (a part of) said spatial information, this second aspect of the invention is rather valuable, in particular when averaged HRTF are used, since averaged HRTF do not exactly represent the effects that take place at a particular user's head. The determination of individualized HRTF is, on the other hand, rather cumbersome and impractical in a typical fitting environment.

The according method of operating a hearing system comprising at least one hearing device may be considered a method for indicating an operational condition of a hearing system. It comprises the steps of:
generating system-generated audio signals;
providing said system-generated audio signals with spatial information, thus creating spatialized system-generated audio signals, in order to achieve the effect that said spatialized system-generated audio signals, when perceived by a user of the hearing system as output signals, are perceived by the user as signals originating from a virtual location;
converting said spatialized system-generated audio signals into output signals to be perceived by said user of the hearing system;
varying said virtual location while said output signals are perceived by said user;
using this variation of said virtual location as an indication of an operational condition of the hearing system.

In a third aspect of the invention, the hearing system comprises
at least one output transducer adapted to converting audio signals into output signals to be perceived by a user of the hearing system; and
at least one sound generator adapted to generating system-generated audio signals;
a virtual localization processor adapted to providing said system-generated audio signals with spatial information;
   wherein said hearing system comprises exactly one hearing device or a number of hearing devices, which are not linked amongst each other.

Although the virtual sound source effect achievable with a binaural hearing system with one hearing device dedicated to each of a user's two ears gives a more realistic impression to the user, it is nevertheless possible to simulate a virtual sound source by means of one single hearing device and with two hearing devices, which are not synchronized with each other. In the case of a single hearing device, spectral coloration and/or reverberation and/or echo signals can be applied as spatial information, and in the case of not-linked hearing devices, in addition, interaural level differences may be applied. In general, that part of HRTF, which does not require a synchronization of hearing devices, may be used in order to simulate a virtual sound source.

Said first, second and third aspects of the invention may be pairwise combined or combined altogether, which can lead to particularly advantageous embodiments. E.g., combining the third aspect with the second aspect (moving virtual sound source) results in an improved distinguishability between different output signals.

Of course, in any case and any aspect of the invention, different output signals (indicative of different parameters) may differ in terms of frequency and spectral content, and in time structure and so on. Through this, the purpose for which signal-generated sounds are generated, can be indicated.

The invention can well be used, when speech signals or more complex sounds are to be generated and presented to the user. The complexity of a sound may manifest in its (large) spectral content, its structure in time or rhythmic or percussive structure. Speech sounds may be used for guiding the user, informing the user and acknowledging events in the hearing system. As opposed to simple “whistle sounds” (typically sine-waves), such more complex sounds can be better localized and more effectively be provided with spatial information. Accordingly, the virtual-sound-source effect is more realistic and therefore of greater use to the user in case of more complex sounds. The simple “whistle sounds” often used as acknowledge sounds are hardly susceptible to a realistic spatialization.

The advantages of the methods correspond to the advantages of corresponding hearing devices.

Further preferred embodiments and advantages emerge from the dependent claims and the figures.

### BRIEF DESCRIPTION OF THE DRAWINGS

Below, the invention is illustrated in more detail by means of embodiments of the invention and the included drawings. The figures show:

FIG. 1 a schematic diagram of a hearing system;

FIG. 2 a schematic illustration of a first and a second aspect of the invention;

FIG. 3 a schematic illustration of a first aspect of the invention;

FIG. 4 a schematic illustration of a second and a third aspect of the invention.

The reference symbols used in the figures and their meaning are summarized in the list of reference symbols. Generally, alike or alike-functioning parts are given the same reference symbols. The described embodiments are meant as examples and shall not confine the invention.

### DETAILED DESCRIPTION OF THE INVENTION

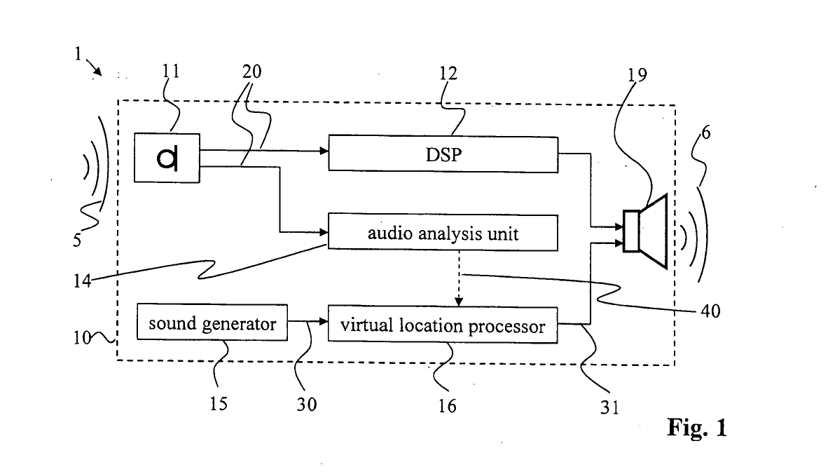

FIG. 1 shows a schematic diagram of a hearing system 1, which comprises at least one hearing device 10. The hearing device 10 comprises an input unit 11 for receiving incoming signals 5. In the case depicted in FIG. 1, the incoming signals are incoming acoustic waves 5, and the input unit 11 comprises one microphone. The input unit 11 obtains input audio signals 20 from said incoming signals 5, which are fed to a signal processor 12, preferably a digital signal processor DSP, by means of which the input audio signals 20 can be adapted to the needs and preferences of a user of the hearing system 1. Said input audio signals 20 are also fed to an audio analysis unit 14, which is used to obtain localization information 40 from said input audio signals 20. Said localization information 40 may comprise data about the distance between the origin of said incoming acoustic waves 5 and the hearing system 1 (or, more precisely, the microphone), and it may comprise data about the direction from which said incoming acoustic waves 5 originate. Said directional information requires the existence of at least two microphones. This may be accomplished by providing said input unit 11 of the hearing device 10 with two microphones, or by providing two hearing devices 10 (typically equally or similarly designed as the hearing device 10 shown in FIG. 1) in the hearing system 1 with at least one microphone each.

How such localization information 40 can be achieved, is known in the art, at least in the area of hearing devices, in conjunction with localizers, beam formers and classifiers.

The hearing system comprises a sound generator 15, which generates system-generated audio signals 30, typically acknowledge sounds indicating a change in the internal (operational) status of the hearing system 1. These system-generated audio signals 30 are fed to a virtual location processor 16, which provides the system-generated audio signals 30 with spatial information, e.g., by applying appropriate (HRTF) filtering and adding reverberation signals, thus generating spatialized system-generated audio signals 31, so as to create the illusion (to the user) that the system-generated signals originate from a certain place or direction (virtual sound source effect).

The place (virtual location), from where the system-generated signals are apparently perceived by the user, is chosen in dependence of the localization information 40.

From said virtual location processor 16 and also from said DSP 12, audio signals are fed to an output transducer 19, which converts said audio signals into output signals 6 to be perceived by the user, which, in the case shown in FIG. 1, are acoustical sound 6.

Said DSP 12, audio analysis unit 14, virtual location processor 16 and sound generator 15 may fully or in part be integrated within the same processor and/or within the same software.

The description of FIG. 1 so far emphasizes a first aspect of the invention, namely the choice of the virtual location in dependence of incoming signals, or, more precisely, of the origin (in space) of sound, which is represented by said input audio signals 20.

Of course, many different algorithms for determining a virtual location (for a system-generated sound) in dependence of one or more localized sound (or noise) source, are applicable.

FIG. 1 may also be interpreted in terms of a third aspect of the invention, which is about creating virtual sound sources when the hearing system 1 comprises only one output transducer 19 or when it comprises two or more output transducers, which are not synchronized to each other (as far as the simultaneousness of the outputting of signals to the user—within the 0.01 ms to 0.1 ms range—is concerned). In that interpretation, the audio analysis unit 14 is optional; the virtual location does not necessarily depend on some localization information.

In FIG. 1, audio signals are represented by solid arrows.

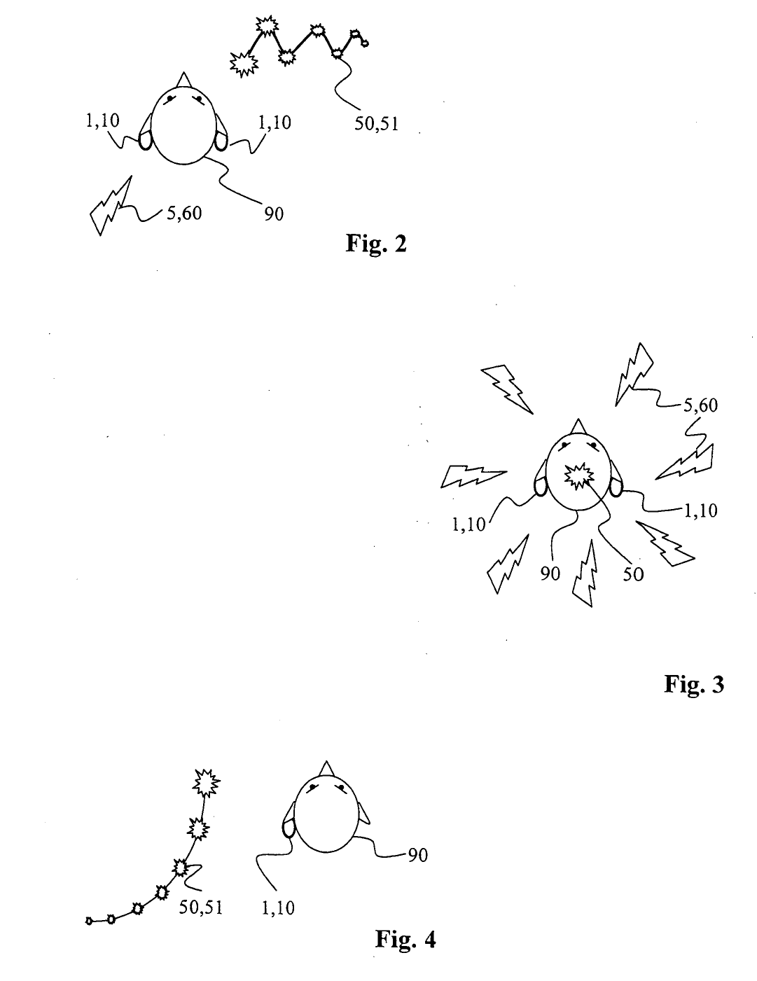

FIG. 2 is a schematic illustration of a first and a second aspect of the invention. Said first aspect is already described above. In FIG. 2, two hearing devices 10, each worn in or near one ear if the user 90, comprise input transducers and a localization processor, so that a (predominant) noise source 60 (which also is an incoming signal 5) can be localized. In FIG. 2, the virtual location of a system-generated sound 50 is chosen such that it appears to originate from a location approximately opposite to the noise source 60 (with respect to the user's head).

Said second aspect of the invention is, that a certain system-generated sound does not only occur at a fixed location, but describes a path (or moves), wherein that path indicates a specific operational condition of the hearing system 1, e.g., that an energy supply of the hearing system is unstable. A corresponding path 51 or virtual movement 51 is indicated in FIG. 2.

FIG. 3 shows a schematic illustration of said first aspect of the invention. In this case, the user 90 is in a noisy environment, in which noise 60 is impinging on the user 90 practically from any direction. This is detected by an audio analysis unit 14, which may be in one or both of the two hearing devices 10 of the hearing system 1. In that case, the virtual location may be chosen, as indicated in

FIG. 3, to be inside the head of the user 90. Accordingly, the spatial information with which the system-generated sounds 30 are provided with, is no reverberation, no echo, no interaural time difference, no interaural level difference and, typically, also no filtering.

FIG. 4 shows a schematic illustration of said second and said third aspect of the invention. According to said third aspect, the hearing system 1 comprises only one hearing device 1 (or, at least, only one output transducer). And nevertheless, a system-generated signal is perceived as coming from a virtual location 50. In addition, said virtual location 50 moves (while being perceived), along a (virtual) path 51 (second aspect).

Of course, a hearing system 1 may comprise a control unit and/or a data acquisition unit, by means of which system parameters (related to an operational condition of the hearing system) can be obtained. Appropriate system-generated sounds (and locations and maybe virtual movement paths) may thereupon be chosen.

List of Reference Symbols
1 hearing system
5 incoming signals, acoustical sound
6 output signals, acoustical sound
10 hearing device
11 input unit
12 signal processor, digital signal processor, DSP
14 audio analysis unit, signal processor
15 sound generator
16 virtual location processor, signal processor
19 output transducer, loudspeaker
20 input audio signals
30 system-generated audio signals
31 spatialized system-generated audio signals
40 localization information
50 virtual location, location of perception of spatialized system-generated sound
51 virtual movement, path
60 noise, noise source, predominant noise source
90 user, hearing system user

1. Hearing system comprising
at least one hearing device;
at least one input unit adapted to receiving incoming signals and obtaining input audio signals from said incoming signals;
at least one output transducer adapted to converting audio signals into output signals to be perceived by a user of the hearing system;
at least one sound generator adapted to generating system-generated audio signals;
an audio analysis unit adapted to obtaining localization information from said input audio signals; and
a virtual localization processor adapted to providing said system-generated audio signals with spatial information, thus creating spatialized system-generated audio signals, wherein said spatial information is chosen in dependence of said localization information.

2. System according to claim 1, wherein said system-generated audio signals are provided with said spatial information in order to achieve the effect that said spatialized system-generated audio signals, when perceived by the user as output signals, are perceived by the user as signals originating from a virtual location, wherein said virtual location is chosen in dependence of said localization information.

3. System according to claim 1, wherein said input unit comprises at least one input transducer, and wherein said localization information comprises room information and/or distance information.

4. System according to claim 3, wherein said room information and/or distance information is obtained from reverberation and/or echo signals comprised in said input audio signals.

5. System according to claim 1, wherein said input unit comprises at least two input transducers, and wherein said localization information comprises at least one of room information, distance information and directional information.

6. System according to claim 5, wherein said localization information comprises directional information, which is obtained from analyzing at least one of
level differences,
spectral differences, and
time-of-reception differences between input audio signals obtained from said at least two input transducers.

7. System according to claim 1, wherein said spatial information comprises at least one of
spectral coloration; and
reverberation and/or echo signals.

8. System according to claim 1, comprising at least two hearing devices, one hearing device for each of the user's two ears, each of the two hearing devices comprising an output transducer, wherein said spatial information comprises at least one of
interaural time differences;
interaural level differences; and
different spectral coloration of output signals to be perceived by each of the user's two ears.

9. System according to claim 1, wherein the kind and/or the amount of said spatial information is chosen in dependence of at least one of
a gain model describing hearing preferences of said user; and
an analysis of said input audio signals.

10. System according to claim 1, wherein said system-generated audio signals comprise acknowledge signals and/or speech signals.

11. Method of operating a hearing system comprising at least one hearing device, comprising the steps of:
receiving incoming signals and obtaining input audio signals from said incoming signals;
generating system-generated audio signals;
obtaining localization information from said input audio signals;
choosing, in dependence of said localization information, spatial information to provide said system-generated audio signals with;
providing said system-generated audio signals with said spatial information, thus creating spatialized system-generated audio signals;
converting said spatialized system-generated audio signals into output signals to be perceived by a user of the hearing system.

12. Method according to claim 11, wherein said system-generated audio signals are provided with said spatial information in order to achieve the effect that said spatialized system-generated audio signals, when perceived by the user as output signals, are perceived by the user as signals originating from a virtual location, wherein said virtual location is chosen in dependence of said localization information.

13. Method according to claim 11, furthermore comprising the step of obtaining room information and/or distance information from said input audio signals.

14. Method according to claim 11, comprising the step of obtaining room information and/or distance information from reverberation and/or echo signals comprised in said input audio signals.

15. Method according to claim 11, comprising the steps of
obtaining at least two streams of concurrent input audio signals from said incoming signals; and
obtaining at least one of room information, distance information and directional information from said at least two streams of input audio signals.

16. Method according to claim 15, comprising the step of obtaining directional information from said at least two streams of input audio signals by analyzing at least one of level differences, spectral differences, and time-of-reception differences between said at least two streams of input audio signals.

17. Method according to claim 11, comprising the step of providing said system-generated audio signals with at least one of
spectral coloration; and
reverberation and/or echo signals
as spatial information.

18. Method according to claim 11, wherein said hearing system comprises at least two hearing devices, one hearing device for each of the user's two ears, comprising the step of providing said system-generated audio signals with at least one of
interaural time differences,
interaural level differences, and
different spectral coloration of output signals to be perceived by each of the user's two ears
as spatial information.

19. Method according to claim 11, comprising the step of choosing the kind and/or the amount of said spatial information in dependence of at least one of
a gain model describing hearing preferences of said user; and
an analysis of said input audio signals.

20. Hearing system comprising
at least one hearing device;
at least one output transducer adapted to converting audio signals into output signals to be perceived by a user of the hearing system;
at least one sound generator adapted to generating system-generated audio signals;
a virtual localization processor adapted to providing said system-generated audio signals with spatial information, thus creating spatialized system-generated audio signals, in order to achieve the effect that said spatialized system-generated audio signals, when perceived by the user as output signals, are perceived by the user as signals originating from a virtual location;
wherein said virtual location is varied while said spatialized system-generated audio signals are perceived by the user as output signals, and wherein this variation of said virtual location is indicative of an operational condition of the hearing system.

21. Method of operating a hearing system comprising at least one hearing device, comprising the steps of:
generating system-generated audio signals;
providing said system-generated audio signals with spatial information, thus creating spatialized system-generated audio signals, in order to achieve the effect that said spatialized system-generated audio signals, when perceived by a user of the hearing system as output signals, are perceived by the user as signals originating from a virtual location;
converting said spatialized system-generated audio signals into output signals to be perceived by said user;
varying said virtual location while said output signals are perceived by said user;
using this variation of said virtual location as an indication of an operational condition of the hearing system.

22. Hearing system comprising
at least one output transducer adapted to converting audio signals into output signals to be perceived by a user of the hearing system;
at least one sound generator adapted to generating system-generated audio signals;
a virtual localization processor adapted to providing said system-generated audio signals with spatial information;
wherein said hearing system comprises exactly one hearing device or a number of hearing devices, which are not linked amongst each other.

23. System according to claim 22, wherein said spatial information comprises at least one of
spectral coloration; and
reverberation and/or echo signals.

24. Method of operating a hearing system comprising the steps of:
generating system-generated audio signals;
providing said system-generated audio signals with spatial information, thus creating spatialized system-generated audio signals, in order to achieve the effect that said spatialized system-generated audio signals, when perceived by the user as output signals, are perceived by the user as signals originating from a virtual location;
converting said spatialized system-generated audio signals into output signals to be perceived by a user of the hearing system;
wherein said hearing system comprises exactly one hearing device or a number of hearing devices, which are not linked amongst each other.
